(19) United States
(12) Patent Application Publication
(10) Pub. No.: US 2020/0328774 A1
(43) Pub. Date: Oct. 15, 2020

(54) MOBILE CASE AND DOCK

(71) Applicant: D&R ELECTRONICS CO. LTD., Bolton (CA)

(72) Inventor: Alfredo DAROLFI, Kleinberg (CA)

(73) Assignee: D&R ELECTRONICS CO. LTD., Bolton, ON (CA)

(21) Appl. No.: 16/845,477

(22) Filed: Apr. 10, 2020

Related U.S. Application Data
(60) Provisional application No. 62/833,007, filed on Apr. 12, 2019.

(51) Int. Cl. H04B 1/3888; H04B 1/3877; H04M 1/725; H04M 1/06

(52) U.S. Cl. CPC H04B 1/3888; H04M 1/06; H04M 1/72527; H04B 1/3877

(57) ABSTRACT

The present invention is a system comprising a handheld computing device case, docking port holder and port housing, that when assembled together operable to connect a handheld computing device fitted within the case with a docking end integrated with the docking port holder whereby the handheld computing device is connected to the one or more ports of the port housing. The connection between the case and the docking port holder is created through engagement along a guide rail path that forms a stable connection that holds the handheld computing device in a position whereby it is securely held and supported, and is operable as a computing device in a stationary environment (e.g., a building, etc.) or a mobile environment (e.g., a vehicle, a boat, or any other moving apparatus). The one or more ports incorporated in the port housing provide connections to one or more peripheral devices operable with the handheld computing device to operate as a computing system. Said case further incorporating an airflow system to prevent overheating of said device.

### CROSS-REFERENCE TO RELATED APPLICATIONS

This application claims the benefit of provisional patent application Ser. No. 62/833,007, filed Apr. 12, 2019, the full content of which is incorporated herein by reference.

### FIELD OF INVENTION

This invention relates in general to the field of integration of a handheld computing device with a case and a docking port connected to one or more additional ports, and more particularly to operability of a handheld computing device to control a computing system.

### BACKGROUND OF THE INVENTION

The popularity of handheld computing devices that are mobile in nature has led to many innovations attempt to increase the scope of use of such devices. One such innovation is the creation of a computing device dock apparatus that allow a handheld computing device to be secured onto a docking station operable to connect the function of the handheld device to one or more ports connectable to peripheral devices, for example, such as a screen, a keyboard and/or other peripheral devices. Such prior art computing device docks may further be operable to hold a handheld computing device in a stationary position whereby the screen of the handheld computing device is facing a user, such that the user can view the screen without needing to hold the device in the user's hand or otherwise having to physically support the device.

Some prior art computing device docks may secure the handheld computing device with a clipping mechanism or a magnet. Such prior art computer device dock do not sufficiently securely support the handheld computing devices to prevent the device from detaching from the holder and being damaged as a result, or from causing harm to the user of the device.

Some prior art computing device docks have are operable to link the electronic device to an electronic cable, for example, such as a charger cable or a headphone jack. Such prior art computer device docks restrict the types of electronic cables that may be linked to the handheld computing device, particularly in a mobile environment.

Examples of prior art include U.S. Pat. No. 9,864,407 issued to Microsoft Technology Licensing, LLC on Jan. 9, 2018, that discloses a mobile computing device dock having connection portions configured to engage the opposing sides of the mobile computing device and more particularly ports disposed on those sides, such connection portions having linked movement, whereby the movement of one of the connection portions causes corresponding movement of the other connection portion. Notably, said invention does not incorporate any airflow system nor can it be used with a variety of shapes, sizes and types of mobile devices.

Another example of prior art is U.S. Patent Application Publication No. 2017/0141594 filed by Anthony Burman and Robert D. Heller on Nov. 12, 2015, that discloses a mobile docking station that includes a casing having a plurality of openings therein, and a cord extending through each opening, each cord having a plug at the distal end thereof. Notably, said invention is not operable to connect a handheld computing device to one or more periphery devices in a secure manner in either a stationary or mobile environment.

Yet another example of prior art is U.S. Patent Application Publication No. 2018/03327324 filed by Tech 21 Licensing Limited on May 10, 2017, that discloses a case for a mobile communications device that includes a main body and a cover. Said cover can be maintained in a closed position by a stud fastener. Notably, said invention is does not incorporate any airflow system, and is not formed to securely connect with a docking station.

Still another example of prior art is U.S. Patent Application Publication No. 2019/0068766 filed by Carydean Enterprises LLC on Aug. 18, 2018, that discloses a case incorporating an internal battery disposed on the body of the case for collecting and distributing energy and a processor, whereby the processor is configured to determine a state of charge of the mobile device battery and the internal battery is connectable to the mobile device to thereby charge the mobile device battery in accordance with the determined state of charge of the mobile device battery. Notably, said invention does not incorporate an airflow system and is not formed to securely connect with a docking station.

What is needed is a mobile case and dock configured to securely hold such case, whereby a handheld computing device can be securely positioned and supported, and through the connection to the dock be connected to other devices, whereby said handheld computer device may function as a computing device in stationary and mobile environments, and further incorporating an airflow system operable to facilitate extended periods of use, continuously during numerous hours, of such handheld computing device in said case and attached to said dock.

### SUMMARY OF THE INVENTION

In one aspect, the present disclosure relates to a computer system for mobile and stationary environments controlled by a handheld computing device, comprising: a case for the handheld computing device, incorporating a guide rail panel thereon; a docking port holder incorporating a guide rail path configured to connect with the guide rail panel; and a port housing connected to the docking port holder and incorporating one or more ports.

In another aspect the present disclosure relates to such computer system wherein: the guide rail panel is a protrusion disposed in the case, having guide rail panel walls extending between the case and the guide rail panel; the guide rail path is an indentation in the docking port holder, having guide rail path walls extending between the docking port holder and the guide rail path; and the guide rail path walls and the guide rail panel walls are configured to correspond to each other such that when fitted together a dovetail connection is formed.

In another aspect the present disclosure relates to such computer system wherein the docking port holder incorporates a connecting end that is a docking end, being connectable with a port disposed in the handheld device.

In another aspect the present disclosure relates to such computer system wherein the guide rail path is configured to incorporate a wider portion at an end distal from the docking end of the docking port holder, and said guide rail path tapers from such wider portion along the guide rail path walls.

In another aspect the present disclosure relates to such computer system wherein the guide rail path is operable to guide the case within the docking port holder by the connection of the guide rail path walls and the guide rail panel walls, to align the docking end and the corresponding port of the handheld computing device.

In another aspect the present disclosure relates to such computer system wherein the docking port holder incorporates a fan system, whereby air flow is generated and directed towards the case when said case is fitted in the docking port holder.

In another aspect the present disclosure relates to such computer system wherein the case incorporates: manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case; one or more airflow indentations extending from the wall of the case proximate or in contact with the handheld computing device is within said case to one or more channels formed between an outerwall of the case and the guide rail panel; and one or more manifold exit holes extending from an end of the channel whereby air flow is dispelled from the one or more channels, whereby air flow is continuously directed to the handheld computing device to prevent overheating of such handheld computing device.

In another aspect the present disclosure relates to such computer system wherein the one or more ports of the port housing are connectable to one or more periphery devices, and when said one or more periphery devices are so connected such one or more periphery devices are controllable by the handheld computing device.

In another aspect the present disclosure relates to such computer system wherein the docking port holder and the port housing are attachable to one or more surfaces.

In yet another aspect the present disclosure relates to a computer system for mobile and stationary environments controlled by a handheld computing device, comprising: a case for the handheld computing device, incorporating a guide rail panel thereon; and a docking port holder incorporating a guide rail path configured to connect with the guide rail panel and an air cooling system.

In another aspect the present disclosure relates to such computer system wherein the docking port holder incorporates a fan system, whereby air flow is generated and directed towards the case when said case is fitted in the docking port holder.

In another aspect the present disclosure relates to such computer system wherein the case incorporates: manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case; one or more airflow indentations extending from the wall of the case proximate or in contact with the handheld computing device is within said case to one or more channels formed between an outerwall of the case and the guide rail panel; and one or more manifold exit holes extending from an end of the channel whereby air flow is dispelled from the one or more channels, whereby air flow is continuously directed to the handheld computing device to prevent overheating of such handheld computing device.

In still another aspect the present disclosure relates to a computer system for mobile and stationary environments controlled by a handheld computing device, comprising: a case for the handheld computing device, incorporating a guide rail panel thereon; and a docking port holder incorporating a guide rail path configured to connect with the guide rail panel and further incorporating one or more ports.

In another aspect the present disclosure relates to such computer system wherein: the guide rail panel is a protrusion disposed in the case, having guide rail panel walls extending between the case and the guide rail panel; the guide rail path is an indentation in the docking port holder, having guide rail path walls extending between the docking port holder and the guide rail path; and the guide rail path walls and the guide rail panel walls are configured to correspond to each other such that when fitted together a dovetail connection is formed.

In another aspect the present disclosure relates to such computer system wherein the docking port holder incorporates a connecting end that is a docking end, being connectable with a port disposed in the handheld device.

In another aspect the present disclosure relates to such computer system wherein the guide rail path is configured to incorporate a wider portion at an end distal from the docking end of the docking port holder, and said guide rail path tapers from such wider portion along the guide rail path walls.

In another aspect the present disclosure relates to such computer system wherein the guide rail path is operable to guide the case within the docking port holder by the connection of the guide rail path walls and the guide rail panel walls, to align the docking end and the corresponding port of the handheld computing device.

In another aspect the present disclosure relates to such computer system wherein the docking port holder incorporates a fan system, whereby air flow is generated and directed towards the case when said case is fitted in the docking port holder.

In another aspect the present disclosure relates to such computer system wherein the case incorporates: manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case; one or more airflow indentations extending from the wall of the case proximate or in contact with the handheld computing device is within said case to one or more channels formed between an outerwall of the case and the guide rail panel; and one or more manifold exit holes extending from an end of the channel whereby air flow is dispelled from the one or more channels, whereby air flow is continuously directed to the handheld computing device to prevent overheating of such handheld computing device.

In another aspect the present disclosure relates to such computer system wherein the one or more ports of the docking port holder are connectable to one or more periphery devices, and when said one or more periphery devices are so connected such one or more periphery devices are controllable by the handheld computing device.

In another aspect the present disclosure relates to such computer system wherein the docking port holder is attachable to one or more surfaces.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a front perspective view of a case of an embodiment of the present invention;

FIG. 2 is a back perspective view of a case of an embodiment of the present invention;

FIG. 3 is a front detailed view of a case of an embodiment of the present invention, showing the vertical air channels within said case;

FIG. 4 is a front perspective view of a first component of a case of an embodiment of the present invention;

FIG. 5 is a back perspective view of a first component of a case of an embodiment of the present invention;

FIG. 6 is a bottom view of a first component of a case of an embodiment of the present invention;

FIG. 7 is a front perspective view of a second component of a case of an embodiment of the present invention;

FIG. 8 is a back perspective view of a second component of a case of an embodiment of the present invention;

FIG. 9 is a bottom view of a case of an embodiment of the present invention;

FIG. 10 is a front perspective view of a docking port holder and mobile multiple port housing of an embodiment of the present invention;

FIG. 11 is a front perspective view of an embodiment of the docking port holder with the front casing of the horizontal platform removed;

FIG. 12 is a front perspective view of a front casing of a platform of an embodiment of the present invention;

FIG. 13 is a rear view of a front casing of a platform of an embodiment of the present invention;

FIG. 14 is a back perspective view of a docking port holder detachable rear portion of an embodiment of the present invention;

FIG. 15 is an exploded view of the docking port holder of an embodiment of the present invention, incorporating an air flow system.

FIG. 16 is a front view of a port housing of an embodiment of the present invention;

FIG. 17 is a perspective view of a desktop port housing of an embodiment of the present invention;

FIG. 18a is a rear perspective view of a detached first component and second component of a case fitted onto portions of a handheld computing device, of an embodiment of the present invention;

FIG. 18b is a front perspective view of a detached first component and second component of a case fitted onto portions of a handheld computing device, of an embodiment of the present invention;

FIG. 19a is a front view of a handheld computing device fitted within a case, of an embodiment of the present invention;

FIG. 19b is a front perspective view of a handheld computing device fitted within a case, of an embodiment of the present invention;

FIG. 20 is a perspective view of the system of the present invention comprising a handheld computing device within a case fitted within a docking port holder connected to a port housing via an electronic cable.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a system comprising a handheld computing device case, docking port holder and port housing, that when assembled together operable to connect a handheld computing device fitted within the case with a docking end integrated with the docking port holder whereby the handheld computing device is connected to the one or more ports of the port housing. The connection between the case and the docking port holder forms a stable connection that holds the handheld computing device in a position whereby it is securely held and supported, and is operable as a computing device in a stationary environment (e.g., a building, etc.) or a mobile environment (e.g., a vehicle, a boat, or any other moving apparatus). The one or more ports incorporated in the port housing provide connections to one or more peripheral devices operable with the handheld computing device to operate as a computing system. Said case incorporates a guide rail path operable to guide a handheld computing device to connect with the docking port holder along a specific path that thereby avoids damage to the connection between said device and a docking end, and creates a secure connection between the case and the docking port holder that prevents said device from disengaging from the docking port holder once so connected. Said case further incorporating an airflow system to prevent overheating of said device.

The term “handheld computing device” as used herein means a mobile phone, a smart phone, a tablet or any similar mobile computing device that is transportable by a user in said user's hand. The term “computing device” as used herein means a device operable as a computer to perform functions of a computer in accordance a computer processor and software code therein or connected thereto.

The terms “periphery device” and “external electronic devices” as used herein mean one or more of the following a keyboard, a speaker, a display, a computing device, a hard drive, a printer, a scanner, or any other device that is operable by or with a computing device to facilitate the function of a computing system.

The term “electronic cable” as used herein means a cable operable to connect the docking housing to a periphery device, whereby said periphery device may be controlled or otherwise operated by a user via a handheld computing device (for example, such as projection of music through a speaker), or achieve a function for the handheld computing device (for example, such as a keyboard operable to produce images upon a screen of the handheld computing device, or a screen connected to the handheld computing device either directly or through the port housing, said keyboard further generating data that is processed by the computer processor of the handheld computing device).

The term “stationary environment” as used herein means an environment that is not in motion, for example, such as a building, or outside upon firm ground. The term “mobile environment” as used herein means an environment that is in motion, for example, such as a vehicle, a vessel such as a boat, an airplane, a spacecraft, or any other environment that is in motion of any type.

The term “connecting end” as used herein means a tip fixedly positioned at the end of an electronic cable or upon a docking port holder or docking housing, whereby such an element that said tip is fixedly connected to can be connected to a port in a computing device, a handheld computing device, or a peripheral device. A tip may be a universal serial bus (USB) tip that connects to a USB port by fitting within such port, a PS/2 tip that connects to a PS/2 port by fitting within such port, an Apple™ device Lightning™ connector tip (a 30-pin dock connector) that forms a 30-pin connection to a 30-pin dock port by fitting within such port, or any other similar connector tip. A connecting end may further be or a type that is connectable to an Ethernet port, a telephone port or any other port now known or developed in the future. The term “port” as used herein means any port that is operable to connect with a connecting end, whereby such connection is operable to facilitate the transfer of information from one device to another (e.g., a handheld computing device to an external device, or an external device to another external device, etc.) in a single direction or a bilateral manner.

Some embodiments of the present invention may be configured for a computing device other than a handheld computing device.

In embodiments of the present invention the port housing may be operable to facilitate wireless connections to one or more external devices.

In embodiments of the present invention the port housing may be integrated with the docking port holder to form a single element of the invention. Such integration may be a fixed connection, or may be a detachable connection.

Various embodiments of the present invention are generated to function in a variety of environments, including stationary and mobile environments. An embodiment of the present that may function in a mobile embodiment consists of the case, a docking port holder, a port housing having one or more ports for connection within one or more types of connecting ends. The docking port holder and port housing may be detachably connected or otherwise affixed to one or more surfaces in the mobile environment.

The case is comprised of two interlocking components that connect to enclose the handheld computing device within the case. The case is further comprised of an extruding portion on the rear of the case that is operable to interlock with a corresponding portion forming a channel within the docking port holder, such that when such extruding portion and such channel portion interlock the case is secured to the docking port holder and the computing device is held in a supported, secure position within said case and docking port holder. The case is further comprised of vertical and horizontal channels that are formed in the interior portion of the back of the case. Air flow generated by a fan positioned in the docking port holder passes through the channels in the case over the portion of the handheld computing device proximate to the case and thereby reduces the temperature of said handheld computing device. The cooling effect of the air flow prevents the handheld computing device from overheating while fitted in the case and positioned in the docking port holder.

In embodiments of the present invention, the docking port holder and case collectively incorporate elements that assist with the secure connection and positioning of the handheld computing device in relation to the docking port holder. Two such elements are the center channel formed in the docking port holder and the complimentary extruding portion formed in the sides and rear wall of the case. The extruding portion of the case is fittable within the channel formed in the docking port holder. The channel in the docking port holder further incorporates a ledge formed in a platform upon which the lowermost edge of the case can rest when the case is fitted within the docking port holder channel. A depressible pin or flexible notch may further be incorporated in the docking port holder channel, and an indentation conforming to the shape and size of said pin or notch may be disposed in the rear wall of the case, such that when the case is fitted within the channel the pin or notch may extend within said indentation. The integration of the pin or notch within said indentation creates a secure connection between the case and the docking port holder, whereby the case is prevented from dislodging or otherwise disconnecting from its integration with the docking port holder when the case is fitted within the docking port holder.

A secure connection between the case and the docking port holder is formed when the case is fit within the docking port holder. This secure connection prohibits the case, or the handheld computing device fitted therein, from shifting in position or disconnecting from the docking port holder unless disconnected by a user. A case or handheld computing device that shifts in position or is disconnected from a docking port holder on its own (meaning without being disconnected by a user) can pose a risk to users in the environment of said device and proximate thereto. For example, such a disconnected handheld computing device and/or case can become a projectile in a mobile environment and can injure a user or other person in such mobile environment, or damage property within such mobile environment.

The connection between the case and the docking port holder may be configured as a guide rail system. The guide rail system comprises elements formed in the walls of the protrusion (the guide rail panel) in the case and the indentation (the guide rail path) within the docking port holder that engage in a secure manner (e.g., a dovetail and/or tongue and groove connection) when the case is moved (e.g., by a sliding movement) so as to be fitted within the docking port holder. The guide rail system creates a path for the case to follow when the case (and the handheld computing device fitted therein) is moved towards the connecting end (the docking end) extending from the docking port holder to connect, said connecting end within a port disposed in the handheld computing device. Said path that the case must follow through operation of the guide rail system avoids damage to the connecting end and the port as the requirement that the guide rail path be followed for the connection to occur forces said connecting end and port into alignment before the connection occurs. An attempt to connect the connecting end and port when such elements are not aligned can cause wear and tear on the connecting end and/or port or damage to said connecting end and/or port.

In embodiments of the present invention, the connection between the walls of the guide rail path of the docking port holder and the walls of the guide rail panel of the case, when the case is fitted within the docking port holder, may be sufficiently closely fitted to each other so as to create friction therebetween. This friction between such walls may increase the strength of the connection therebetween, and further add to the secure connection formed between the docking port holder and the case.

The docking port holder also comprises an airflow system comprised of a fan and one or more air flow channels formed in the case. Such channels within the case may further have indentations and/or holes formed therein. Such holes may extend through the case from the interior wall of the case through to the outer wall of the case. The fan generates air flow that circulates between the case and the handheld device, through the channels, and out of the case through manifold exit vents when the case is secured into the docking port holder. The combination of channels and indentations or holes formed in the case comprise an airfold manifold, whereby the airflow moving along the channels can gather within the indentations to provide prolonged cooling to the handheld computing device before being dispelled from the case through the manifold exit vents.

The fan can be positioned in the case or the docking port holder. A door or other element providing access to the fan may be incorporated in the case or docking port in proximity to the fan, depending which element the fan is positioned within. Said door or other access element may provide access to the fan. This access may assist with altering the settings for the fan, fixing or replacing any elements of the fan, for example, such as the fan blades, any screen surrounding the fan blades, the motor for the fan, or other elements relating to fan. The access thereby provided may further allow a user to unclog a fan should debris be caught within the fan thereby clogging the fan and diminishing its functionability. The fan may further be accessible through a detachable connection between sections of the docking port holder.

Embodiments of the present invention incorporate a port housing. The port housing comprises a connection to the docking port holder that may be a wired connection or a wireless connection, and connections to one or more peripheral devices via wired or wireless connections or a combination of wired and wireless connections. In some embodiments of the present invention, the docking port holder may be integrated with the port housing into a single unit through a fixed or detachable connection.

Some embodiments of the invention may be configured such that one or more connections between the handheld computing device and peripheral devices are wireless connections, and in such embodiments the port housing may not be incorporated in the invention, or may be configured to generate wireless connections between the handheld computing device and one or more or the peripheral devices.

In embodiments of the present invention, the docking port holder may be secured to a surface of a mobile or stationary environment. For example, an embodiment of the present invention that is utilized in a vehicle, may incorporate an element for securing the docking port holder to the dashboard of the vehicle or to an armrest or other surface in the vehicle. As another other example, an embodiment of the present invention that is utilized in a stationary environment, the docking port holder may be secured to a wall of a building or to the surface of furniture, such as to the top surface of a desk.

In embodiments of the present invention, the port housing may be secured to a surface of a mobile or stationary environment. For example, an embodiment of the present invention that is utilized in a vehicle, may incorporate an element for securing the port housing to the dashboard of the vehicle or to an armrest or other surface in the vehicle. As another other example, an embodiment of the present invention that is utilized in a stationary environment, the port housing may be secured to a wall of a building or to the surface of furniture, such as to the top surface of a desk.

The port housing and the docking port holder may be positioned in proximity to each other, or may be positioned remotely from each other.

A handheld device is operable in accordance with software applications and other software therein, functions incorporated therein (e.g., cameras, GPS, etc.), and information and software accessible through the Internet and any intranet, extranet or other network to which said device is connectable.

In embodiments of the present invention, the case of the present invention may be formed to hold or otherwise incorporate a variety of sizes and shapes of handheld computing devices. For example, in embodiments of the present invention, the interior of the case may be configured to hold or otherwise incorporate handheld computing devices of one or more sizes or shapes, such that the interior of the case may incorporate flexible or adjustable elements to hold or otherwise incorporate said handheld computing device. In other embodiments of the present invention, the interior of the case may be configured to hold or otherwise incorporate a specific size and/or shape of handheld computing device. The cases of all embodiments of the present invention, will be configured to incorporate a protrusion having extrusions in the walls extending therefrom that are formed to fit within and integrate with the channels in the docking port holder (e.g., collectively forming a guide rail system).

In embodiments of the present invention, the case may be configured to so that a handheld computing device can be fit within the case by the sections of the case (e.g., the first component and second component) being detached, and each section being engaged with an opposite end of the handheld computing device, and the section thereafter being moved towards each other and engaged when the section make contact, or nearly make contact. In this manner different sizes and shapes of handheld computing devices can be fit within the case.

In other embodiments of the present invention the case may be formed of a flexible material, such that it can be stretched and twisted so that the handheld computing device can be fitted within the case without the need to detach any sections of the case. In such an embodiment of the present invention, the case may be formed as a single unit, and it may not be formed of multiple sections.

In embodiments of the present invention, there may be friction created between one or more walls of the case that are positioned proximate to, or in contact with the handheld computing device when the handheld computing device is fitted within the case, and the walls of the handheld computing device. Such friction may act to cause the handheld computing device to remain securely positioned within the case.

In embodiments of the present invention, the case may be formed of a flexible materials, such as any of the following, or a combination of the following, materials metal, nylon, plastic, polyurethane, polycarbonate, carbon fiber, silicon and so forth. The flexible material that the case is formed of allows for the case to fit snugly around a handheld computing device fit within, and for the case to be flexed away from the handheld computing device to extract said device from the case.

In embodiments of the present invention, the docking port holder may be formed of metal, nylon, plastic, polyurethane, polycarbonate, carbon fiber, silicon and so forth.

In embodiments of the present invention, the port holder may be formed of metal, nylon, plastic, polyurethane, polycarbonate, carbon fiber, silicon and so forth.

In embodiments of the present invention, all or some of the elements of the present invention may be 3-D printed.

As an example, the present invention may be utilized by a law enforcement officer, such as a policeman. The officer may spend time in a car driving to various locations, and out of the car, during a shift. The time spent out of the car may involve gathering information from a variety of persons, such as by taking pictures, and writing notes. The time spent in the car may further involve collecting information relating to activities of people viewed through the windows of the car, and taking calls from a police station. All of these activities of an officer may be required to be reported by the end of the officer's shift. With the prior art, the officer may be required to return to the station prior to the end of the shift and use a computer system in the station to prepare reports. The present invention facilitates a computer system being operable in the officer's car, whereby the officer can prepare reports and undertake other activities that require a computer system without having the return to the station to do so. This is an advantage in that the officer can prepare reports and undertake other activities that require a computer system on the fly during a shift. The result is that the station will receive information relating to an officer's activities in real time or virtually real time (if reports are sent by the present invention to the station computer system either via an Internet connection or another connection whereby such transfer is facilitated), as there is no need to wait until the officer returns to the station for the officer to provide such information.

The officer further will not need to download pictures or notes collected in the officer's handheld computing device to a computer system at the station. The officer's handheld computing device that the officer utilizes while in and out of the car will be integrated in the computer system. The fact that there is no need to download information further makes the collection of information and the application of such information to reports a more efficient and less time consuming process.

The present invention offers several benefits over the prior art. In particular, one such benefit of the present invention over the prior art is that the present invention creates a secure and stable connection between the handheld computing device and the docking port holder. Prior art mobile device docking systems do not create a secure connection between a mobile device (such as a handheld computing device) and the docking apparatus, and consequently the mobile device can dislodge or disconnect from said docking system. A dislodged or disconnected mobile device can pose a risk of injury to a person or damage to furniture, walls or other elements within a mobile or stationary environment. In particular, in a mobile environment a disconnected mobile device can become airborne which increases the risk of it causing injury or damage. Thus, the configuration of the present invention negates such risks posed by prior art systems due to an insecure connection between a device and a docking port.

The present invention offers yet another benefit over the prior art in that the guide rail system guides the case encasing the handheld computing device along a consistent path towards the connecting end incorporated in and extending from the docking port holder. Once said case is fully fitted within the docking port holder said connecting end will be fitted within the corresponding port disposed in the handheld computing device. The path ensures that that the connecting end and port are aligned when they connect and disconnect. Prior art systems do not incorporate such a guide rail system, and therefore a connecting end that the port of a mobile device (such as a handheld computing device) will integrate with may not be aligned with said port as the connecting end and port are moved towards each other. The result of said connecting end and said port being unaligned when they connect, or disconnect is that the connecting end may become damaged because it will be twisted or struck due to the lack of alignment. A damaged connecting end and/or port may diminish the function of the mobile device or cause it to fail to function with one or more peripheral devices connected thereto.

In the instance that such damage is inconsequential initially, it could increase in significance over time as the mobile device is connected and disconnected from the connecting end multiple times. This is a substantial problem for prior art systems as the port and the connecting end may be connected and disconnected frequently, even during a few hours of time. For example, prior art systems used by law enforcement officers may involve such users connecting and disconnecting the port of a mobile device from a connecting end of a docking station each time said officer enters and leaves their vehicle. This is due to the fact that the mobile device is connected with the docking station when the officer is in the vehicle and it is disconnected when the officer exits the vehicle. Said officer may enter and exit the vehicle multiple times during a shift. Therefore, the guide rail system of the present invention provides protection to the connecting end of the docking port holder and port of the handheld computing device, and thereby protects the function of the handheld computing device from diminishment and failure, increasing the reliability of such function over prior art systems.

Still another benefit of the present invention over prior art is that the present invention incorporates an air flow system. In embodiments of the present invention, the airflow system circulates air flow within the case and between the case and the handheld computing device. Such airflow can function to prevent the device from overheating and/or to cool the handheld computing device. Mobile devices (such as handheld computing devices) can generate heat if in use for extended periods of time, or may become hot due to use in high temperature mobile or stationary environments. Prior art docking system and mobile device cases do not include any air flow system, and therefore mobile devices used with prior art systems are prone to overheating. Some possible effects of overheating can be damage to the mobile device, diminished functionability of such mobile device, and/or failure of the functionability of the mobile device. The airflow system of the present invention therefore offers a benefit over prior art systems in that it is operable to cause airflow to be disposed in a manner that avoids and averts overheating of a handheld computing device.

Yet another benefit of the present invention, is that it is operable to facilitate the use of a handheld device to control and operate a computer system. In embodiments of the present invention the handheld computing device is the dominant element of computing functions in a computer system. The present invention allows the handheld computing device to be connected to one or more periphery devices, and thereby permits the handheld computing device to be the driver for creating a computing system operable to achieve office functions in any environment, including any mobile environments. This is of great assistance to professionals such as law enforcement agents who spend many hours each day working from their car. The size of the office computing system required to operate functions required for such agent's work is reduced from that of traditional office systems because the base computing element of the system of the present invention is the handheld device, but the function of such device is comparable to that of a traditional office system. Moreover, said agent can transition easily between use of a handheld computing device detached from the docking port holder and from the one or more periphery devices connected to the port housing to use of the handheld computing device connected to the docking port holder and to one or more periphery devices that collectively create a computing system. Said agent may detach and attach a handheld device from the docking port holder many times during a work shift. Essentially, the agent can move from street work with a handheld computing device, to undertaking work that would otherwise have to wait until said agent returned to an office through use of the computing system of the present invention when the handheld computing device is attached to the docking port holder. The prior art systems are not capable of achieving the same function and ease of detaching a mobile device from and attaching it to a commuting system, as is achieved by the present invention.

Embodiments of the present invention are shown in the drawings as examples of possible embodiments of the present invention. Other embodiments and configurations of the present invention are also possible, as discussed herein.

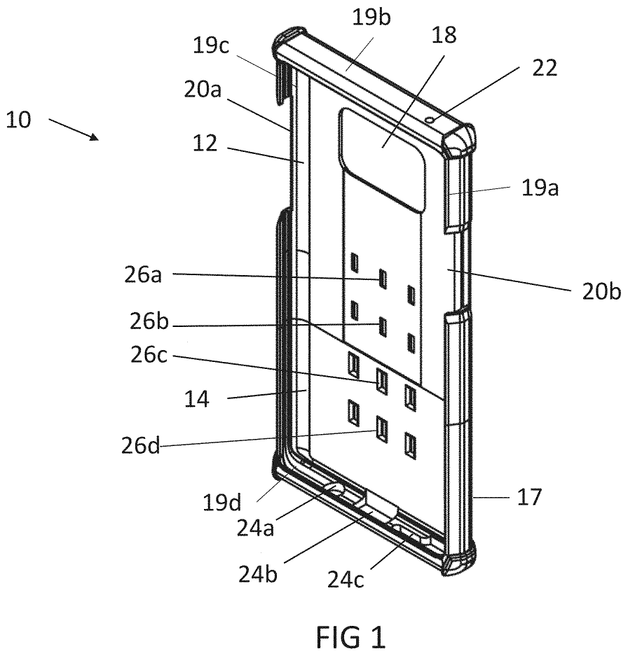

An embodiment of the present invention comprises a case such as that shown in FIG. 1. The case 10 is formed to comprise a rectangular wall 17, with four sidewalls 19a, 19b, 19c, 19d attached thereto. Each sidewall is attached to an edge of the rectangular wall at an angle that is approximately a 45 degree angle. In some embodiments the connection between the rectangular wall and one or more of the sidewalls may be a right angle or approximately a right angle, or a curved or sloping connection. The rectangular wall may incorporate rounded corners or right angle corners where the sidewalls connect to each other.

The side walls and the rectangular wall may incorporate indentations, extrusions, holes or cutouts to assist with providing access to elements that permit functions of a handheld computing device when said device is fitted in the case, for example, such as control buttons, camera lenses, headphone jacks, microphone jacks, 10-pin or 30-pin ports, or other control elements of said device. For example, a headphone hole 22 may be formed in a sidewall permitting access to a headphone jack or one or more other ports in the wall of the handheld computing device. As other examples, port holes 24a, 24b and 24c may be formed in a sidewall to allow for access to other ports in the wall of a handheld computing device. Cutouts 20a and 20b may further be formed in the sidewalls to permit access to volume controls, power controls, or other buttons or controls incorporated in a handheld computing device. The positioning of such holes, cutouts, indentations or extrusions in the sidewalls of the case may be in proximity to such buttons, ports, elements and/or other controls in the handheld computing device that is to be fitted into the case in an embodiment of the present invention. As such, the case may be formed to be utilized with a particular type of handheld computing device and the holes, cutouts, indentations or extrusions in the sidewalls may be positioned to coordinate with the position of buttons, ports or other controls in such type of handheld computing device, in an embodiment of the present invention wherein the case is configured for use with a specific type of handheld computing device. Whereas, the holes, cutouts, indentations or extrusions in the sidewalls may be positioned where such buttons, ports, elements and/or other controls are generally incorporated in several types of handheld computing devices in embodiments of the present invention configured for use with multiple types of handheld computing devices.

The rectangular wall of a case may incorporate cutouts for access to elements that permit functions of the handheld computing device, for example, such as a window cutout 18 permitting access to a camera lens in a handheld computing device, or for access to other elements that permit functions of the handheld computing device.

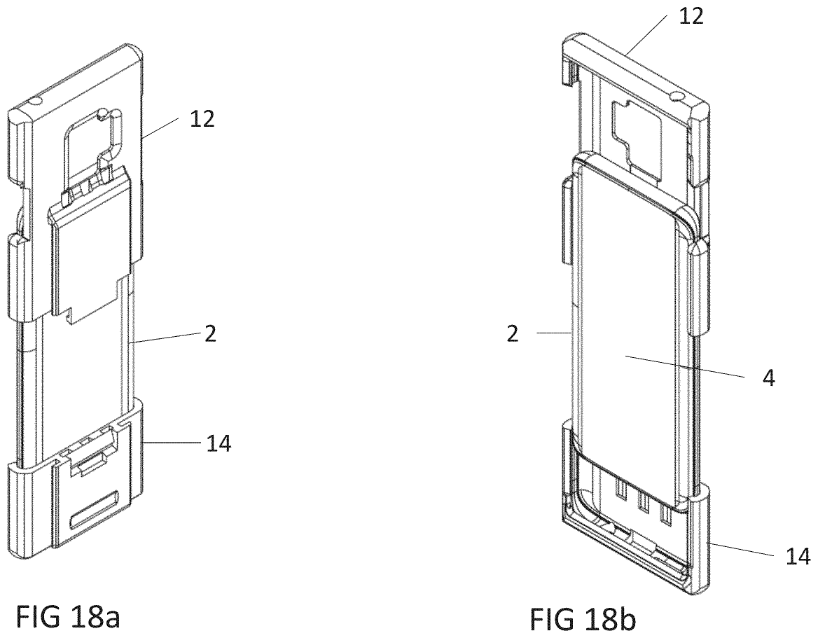

As shown in FIGS. 18a and 18b a handheld computing device 2 is positionable within the case 10, whereby a screen 4 of said handheld computing device is accessible to the user and is not covered or is only partially covered by any wall of the case. The walls of the handheld computing device, other than the screen, may be in contact with, or proximity to, the sidewalls and rectangular wall of the case when the handheld computing device is positioned within the case.

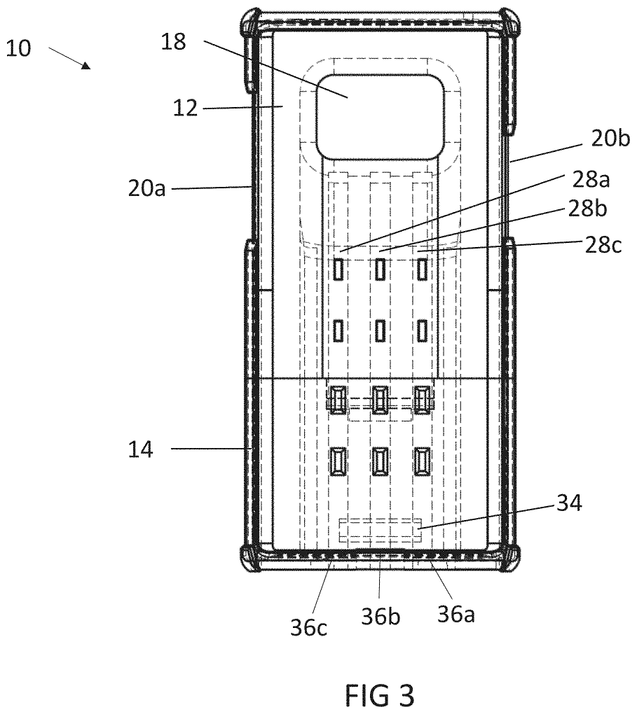

As shown in FIG. 1, the case may have one or more air flow indentations 26a, 26b, 26c, 26d, formed therein on the side of the rectangular wall that will be in contact with a wall of the handheld computing device when said device is fitted in the case. Said indentations may be a consistent size, or may be of variant sizes. As shown in FIG. 3, said indentations may be positioned within or in proximity to one or more channels 28a, 28b, 28c formed in the side of the rectangular wall opposite to the side of the rectangular wall that will be in contact with a wall of the handheld computing device when said device is fitted in the case, namely the outerwall 33a, 33b of the rectangular wall. Said channels may be formed as grooves or other indentations in the outerwall of the rectangular wall. Each air flow indentation may be a hole whereby air can flow between such air flow indentation and a channel. Air flow indentations may collectively be operable to permit air flow to and from multiple channels.

The channels may be formed to be comprised of grooves in the outerwall of the rectangular wall, and/or grooves in the side of the guide rail panel that is in contact with a portion of the rectangular wall. In this manner the channels are enclosed between the outerwall of the rectangular wall and the guide rail panel. Said channels may incorporate manifold holes at one or more ends of each channel, whereby air flow can flow in and out of the channel from outside of the case.

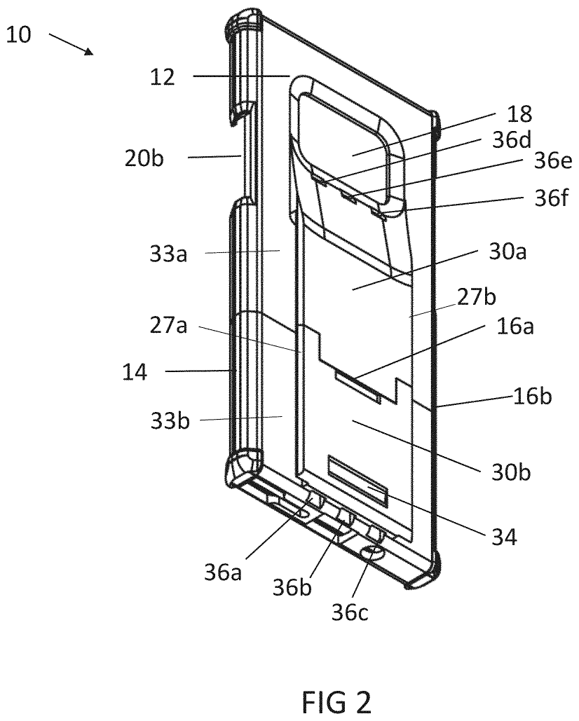

As shown in FIG. 2, the outerwall of the rectangular wall incorporates a guide rail panel and said guide rail panel may be divided into two or more sections 30a, 30b. The guide rail panel is formed to extend from the surface of the outerwall of the rectangular wall of the case as a protrusion, and such protrusion forms guide rail panel walls 27a, 27b extending between the outerwall of the rectangular wall and the wall of the guide rail panel that will be facing the guide rail path when the case is fitted into the docking port holder. Said guide rail panel walls are positioned to be parallel or virtually parallel to each other, and are configured to engage with the guide rail channel of the docking port holder when the case is fitted within said docking port holder.

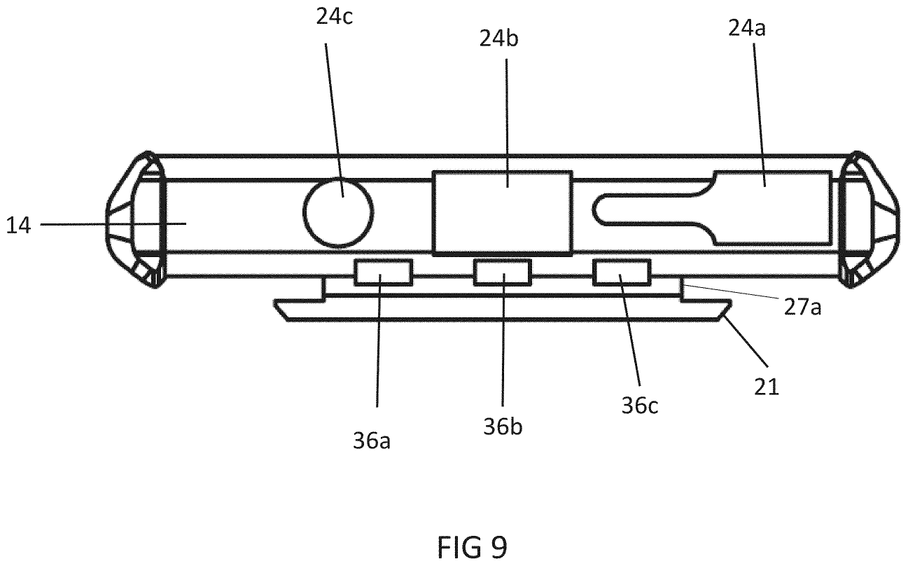

The engagement of the guiderail channel of the docking port holder with the guide rail panel is configured to achieve a dovetail and/or tongue and groove fit in embodiments of the present invention. For example, as shown in FIG. 9, the guide rail panel walls may incorporate a panel wall flange 21 extending outwardly from the guide rail panel walls. The guide rail path walls may be configured to receive such flange within a groove formed in the guide rail path walls, whereby a dovetail and/or tongue and groove fit is achieved when the guide rail panel is combined with the guide rail path. The guide rail panel walls are slidably engaged with the guide rail path walls, and thereby form a secure connection when integrated. Such connection is easily disengaged when the guide rail panel walls are slidably disengaged from the guide rail path walls, as occurs when the case is slid out of the docking port holder.

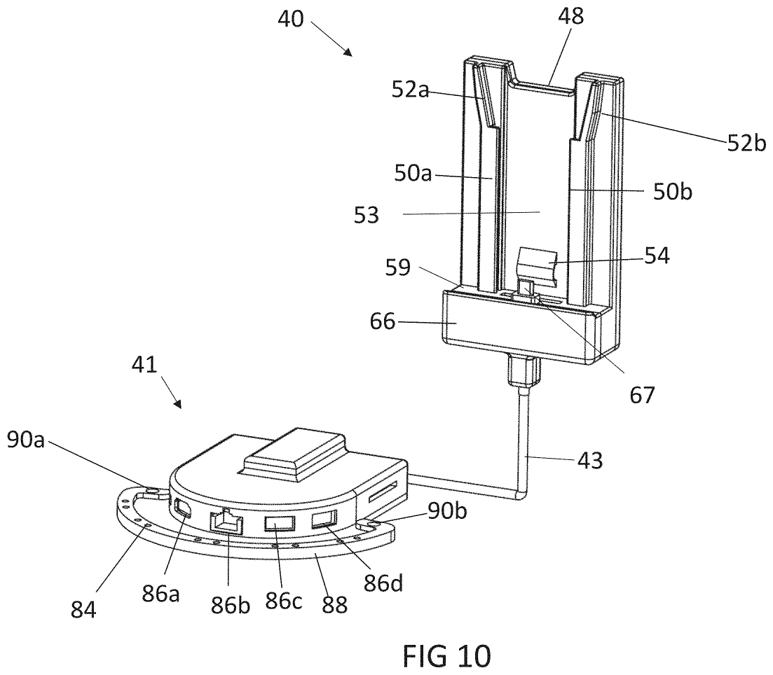

Said outerwall of the rectangular wall of the case may further incorporate a locking element 34 configured to receive a locking protrusion or locking pin formed in the docking port holder. (For example, the locking protrusion 54 of the docking port holder as shown in FIG. 10, may be configured to extend into such locking element when the case is fitted within the docking port holder.) The combination of the locking elements and locking protrusion or locking pin is operable to increase the security and stability of the connection between the case and the docking port holder, when the case is fitted within the docking port holder.

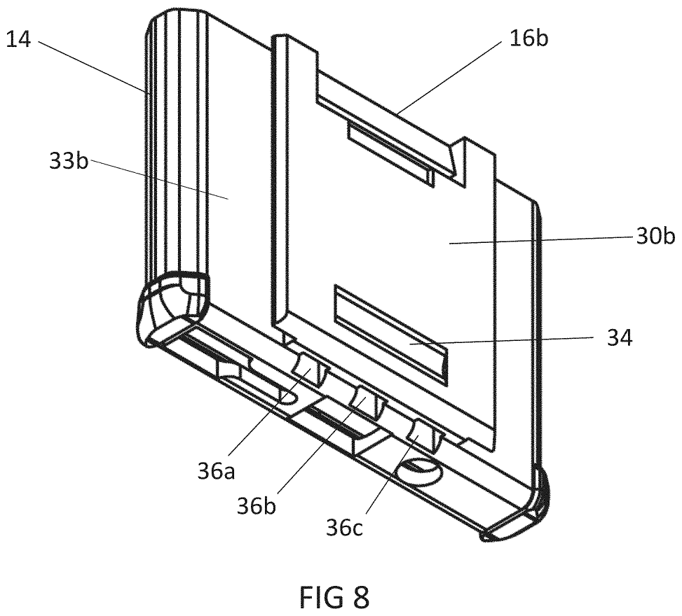

In embodiments of the present invention, as shown in FIG. 2, the case is comprised of two components, a first component 12 and a second component 14. Said first component and second component being connectable and disconnectable by the operation of a latching element, comprised of a first latching element section 16a (as shown in FIG. 2), and a second latching element section 16b (as shown in FIG. 8). In embodiments of the present invention, the latching element is an interlocking clip operable to hold the first component and second component in an integrated position when the latching element is engaged. The latching element may be disengaged by a user, for example by way of depressing or lifting of a section of the latching element in accordance with known latching mechanism configurations.

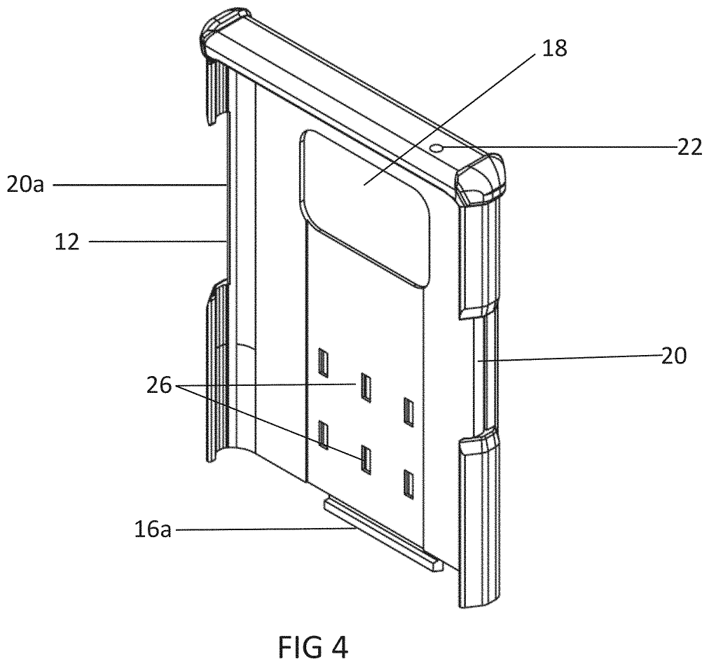

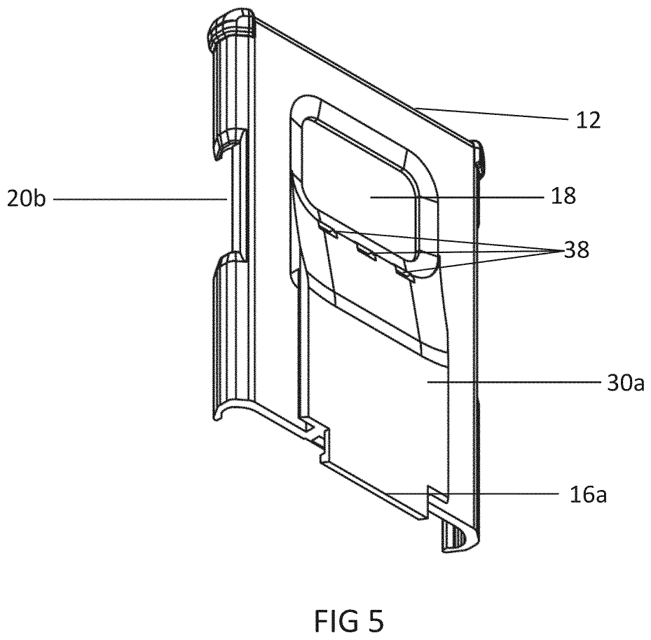

As shown in FIGS. 4 and 5, the first component 12 may be fully disengaged and separated from the second component. The first component incorporates a first latching element section 16a that extends from a portion of the rail guide panel in the direction of the position of second component when the second component is integrated with the first component. Said first latching element section incorporates a flange, ledge, or other element that is interlockable with the second latching element section or a portion thereof when the first component and second component are integrated.

In embodiments of the present invention, the latching element may function as a clip, whereby the first latching element section clips onto the second latching element section.

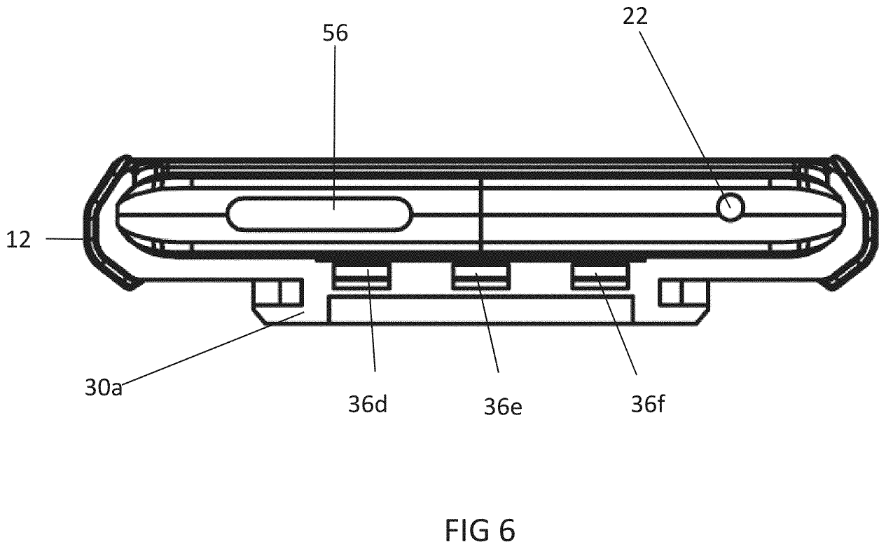

As shown in FIG. 6, the first component of the case may incorporate one or more first component manifold exit holes 36d, 36e, 36f, whereby air flow can be either drawn into or dispelled from the interior of the case and the channels in particular to which said manifold exit holes (the manifold exit vents) are connected.

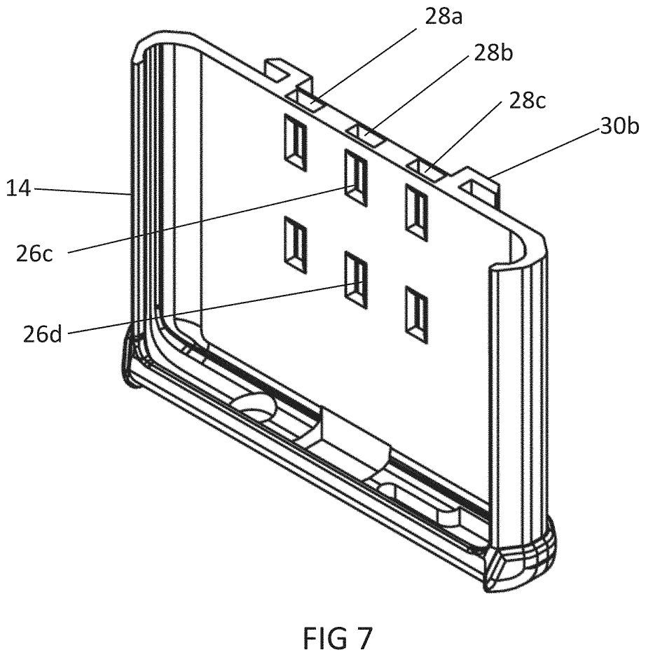

As shown in FIGS. 7 and 8, the second component 14 may be fully disengaged from the first component. The second component incorporates a second latching element section 16b that is an indentation configured to correspond to the first latching element section, such that when the second component is integrated with the first component, said second latching element section interlocks with the flange, ledge, or other element of the first latching element section or a portion thereof and the first component and second component are secured in an integrated and combined manner to form the assembled case.

As shown in FIG. 9, the wall of the second component that is distal from the second latching element section, namely the lower wall 19d, or a section of the rectangular wall proximate to said lower wall, may incorporate one or more second component manifold entrance holes 36a, 36b, 36c, whereby air can flow so as to contact the side of the rectangular wall that is in contact with or proximate to the handheld computing device when it is fitted within the case. Air can flow into and out of the interior of the case via such manifold entrance holes.

As shown in FIG. 7, the channels 28a, 28b, 28c formed between the outerwall of the rectangular wall of the case and the rail guide panel may extend through the second component 14 and connect with corresponding channels in the first component 12. When the case is assembled, channels be comprised so as to extend through the whole of the combined first component and second component. In embodiments of the present invention, one or more such channels are closed at one end and have manifold exit holes at the other end of each channel, said manifold exit holes being formed in the first component.

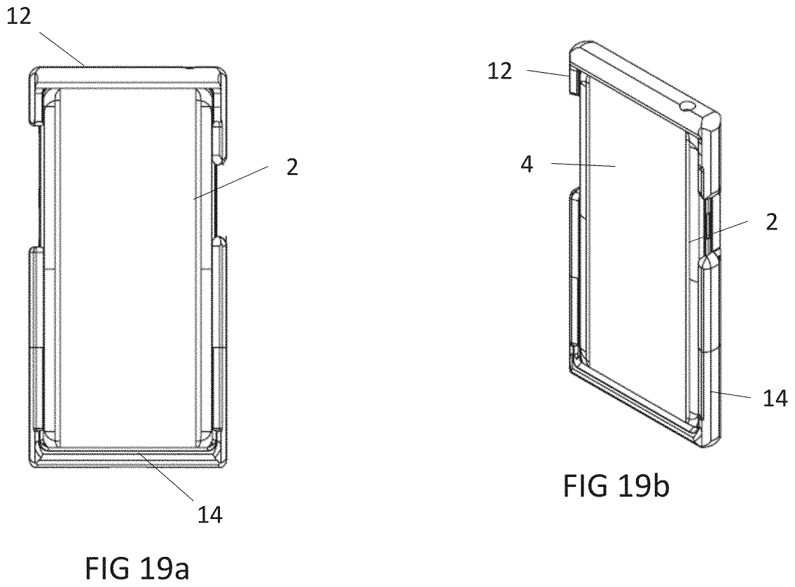

As shown in FIGS. 19a and 19b, the handheld device 2, may be fitted within the first component 12 and second component 14 of the case when said first component and second component are detached from each other. The first component and second component can each be fitted to connect with opposite ends of a handheld computing device, and upon such connection then first component and second component can be moved towards each other until such components meet and can be, or are in sufficient proximity to be, attached to form the case having a portion of the handheld computing device within said case. The handheld computing device should be positioned such that the screen 4 is facing away from the rectangular wall of the case and said screen is uncovered or virtually fully uncovered by any portion of the case.

In other embodiments of the present invention, the case may be formed mf a material that is flexible and can be stretched and flexed, such as to be fit around a portion of the handheld computing device without detaching the first component from the second component, whereby the handheld computing device is thereby fit within the case in accordance with the present invention.

To detach the case from said handheld computing device a locking or latching mechanism between the first component and second component can be disengaged, and the first component and second component can be moved away from each other until the handheld computing device is no longer in contact with either the first component or second component.

As shown in FIG. 10, an embodiment of the system of the present invention may incorporate a docking port holder 40 attached to a port housing 41. The docking port holder 40 comprises a connecting end that is a docking end 67 that is connectable to a port in the handheld computing device. The docking end 67 is disposed at one end of an electronic cable that is a docking end cable 43 that extends from the docking end to the port housing 41. The port housing incorporates one or more ports whereby one or more external devices are connectable to said port housing and thereby to the handheld computing device.

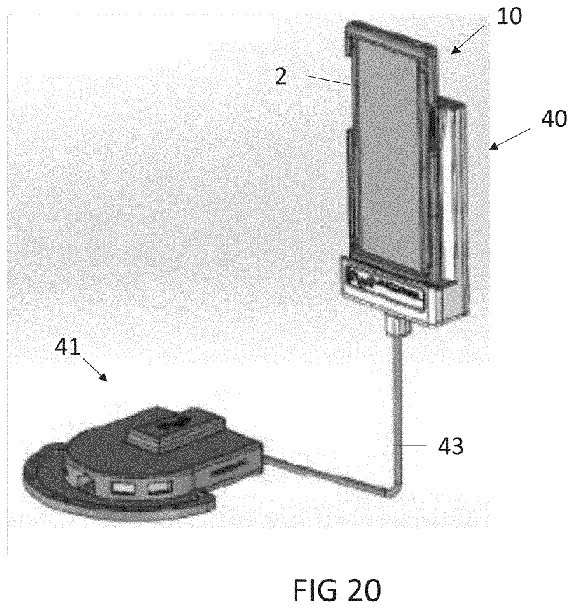

As shown in FIG. 20, the handheld computing device 2 can be fit within the case 10, and said case can be fit into the docking port holder 40, whereby said handheld computing device is connected to the port housing via the docking end cable 43. When the docking end is connected to a port in the handheld computing device said handheld computing device is connected to the port housing and the one or more peripheral devices connected to ports therein, and said handheld computing device is operable to control the function of said external devices and to transfer information to and from such external devices to support such control and function.

As shown in FIG. 10, the docking port holder further comprises a guide rail path 53 configured to receive the guide rail panel of the case. The guide rail path is formed as an indentation in the docking port holder. The indentation forms guide rail channel walls 50a, 50b extending from the indentation to the front-facing side of the docking port holder. Said guide rail channel walls are configured such that each of the guide rail panel walls will be in contact with one of the guide rail channel walls, or a portion thereof, when the case is fitted into the docking port holder. Such contact may create friction between such walls that increases the support and stability of the secure connection formed between the case and the docking port holder. The guide path channel walls incorporate angled walls 52a, 52b that are configured to form a wider path at the point where the case will first pass into said guide rail path than the portion of said guide rail path wherein the guide rail panel walls will be in continuous contact with the guide rail path walls. The wider path is positioned distal from the docking end. The angled portion of said guide rail path forms only a section of the entire guide rail path, the rest of the guide rail path is formed between parallel or virtually parallel guide rail path walls.

The wider path and the angled portion of said section of the guide rail path is operable to permit a user to insert the case into the guide rail path in manner whereby the case does not need to be positioned such that the port of the handheld computing device within the case to be connected with the docking end is aligned with the docking end. As the case moves along the path in the direction of the docking end, the guide rail panel walls and the guide rail path walls will come into contact, whereby each guide rail path wall comes into contact with one of the guide rail panel walls. This contact will guide the case into a position whereby the port of the handheld device is facing the docking end, and is aligned with said docking end. Such alignment will cause the docking end to connect with said port of the handheld device in a manner whereby there is no striking twisting or other stress exerted upon the docking end or the port. The integrity of the docking end and the connection between the port and the docking end is thereby protected.

The guide rail path walls and the guide rail panel walls may incorporate one or more corresponding ridges, flanges, grooves or other configurations that are integrated when said guide rail panel walls of the case and the guide rail path walls of the docking port holder are connected and thereby integrated. Such ridges or other configurations may integrate so as to form a secure connection between the case and the docking port holder. Said ridges may form a dovetail and/or tongue and groove connection between the guide rail path walls and the guide rail panel walls.

The port housing is configured to incorporate one or more ports connectable with one or more connecting ends. Each port being operable to connect with one connecting end. For example, the connecting end connected to a periphery device may be connected to one of said ports, and said periphery device may thereby be connected to or otherwise linked to a handheld computing device that is connected to the docking end of the docking device holder. When so connected to a handheld computing device, said one or more periphery devices may be controlled by or otherwise utilized with said handheld computing device. In this manner the handheld computing device may be utilized in the same manner as, or as a replacement for a desktop computer.

The port housing 41 may be mountable to a surface, and may incorporate a mounting element. For example, an embodiment of the present invention may incorporate a mounting element 88 that incorporates on or more mounting holes 90a, 90b. Said mounting holes may be utilized to attach the port housing to a surface, for example, such as by way of screws inserted through the mounting holes and fixed into said surface.

The mounting element may further incorporate one or more electronic cable stabilizing elements. For example, an embodiment of the present invention may incorporate one or more cable holes within the mounting element, whereby an electronic cable inserted into a port of the port holder may be positioned over the mounting element proximate to such one or more cable holes. Ties, such as string, metal or other ties, can be inserted through said holes proximate to said electronic cable and thereby encompass said electronic cable, and bind said electronic cable to the mounting element. Said binding of the electronic cable can hold the electronic cable in a specific position in relation to the port, and thereby reduce stress upon the connection between the connecting end of the electronic cable and the port that may otherwise occur due to the effect of movement and twisting of said electronic cable attached to said connecting end in relation to the port.

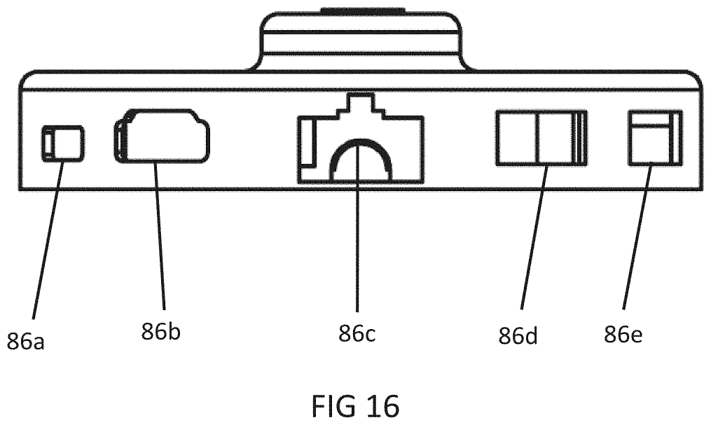

The port housing may be of any shape or configuration, and is merely required to provide access to one or more ports, whereby one or more connecting ends attached to one or more external devices can be connected to the one or more ports of said port housing. The number of ports incorporated in a port housing may vary, as shown in FIG. 16, some port housing embodiments, may incorporate five different ports 86a, 86b, 86c, 86d, 86e, and other embodiments may incorporate still other numbers of ports. The one or more ports disposed in a port housing may be the same type of port, or one or more of such ports may be different types.

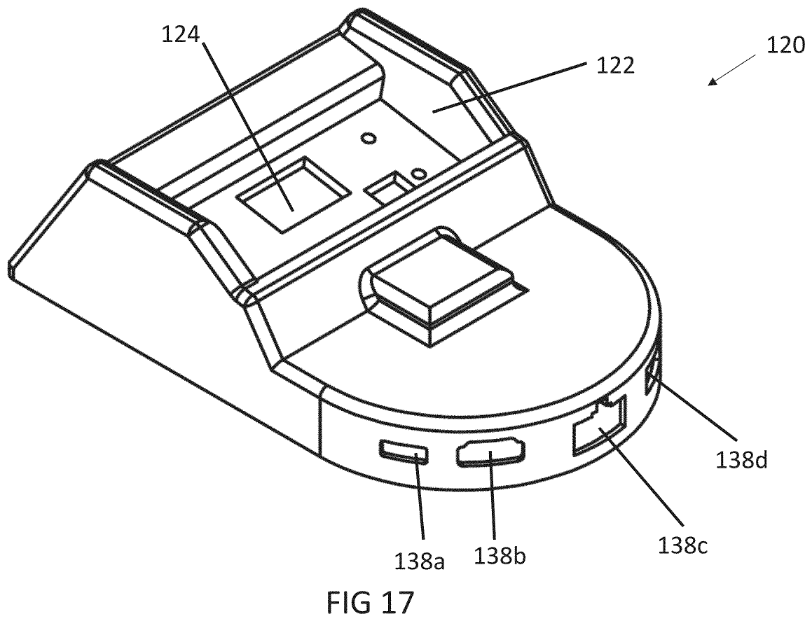

As shown in FIG. 17, an embodiment of the present invention may incorporate a port housing 120 having a docking port holder support 122 disposed therein and further comprising a cable exit receiver 124, and multiple ports 138a, 138b, 138c, 138d, whereby a docking port holder may be positioned upon the port housing, and the cable exit of the platform of the docking port holder may be inserted within the cable exit receiver, such that the docking port holder is connected to and integrated with the port housing. For example, such an embodiment of the present invention may be utilized in a small space, or a stationary environment (e.g., upon a desk or elsewhere in a stationary environment.)

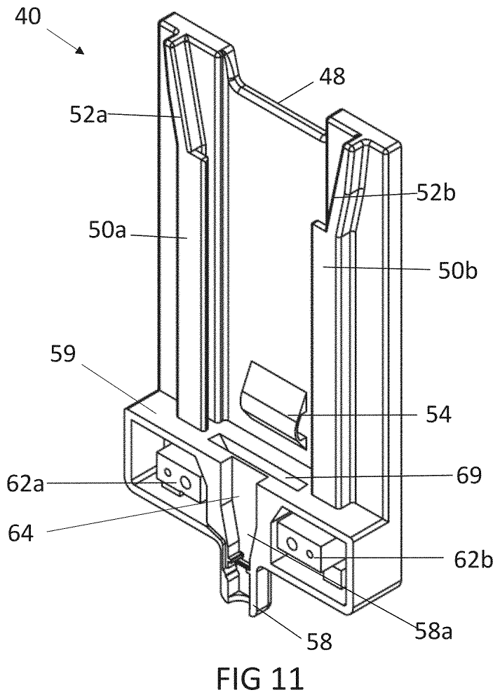

As shown in FIG. 11, the docking port holder 40 comprises a connector housing 64 formed within a platform 59 of said docking port holder. Said connector housing being configured to receive a connecting end and electronic cable attached thereto that will be attached to the handheld computing device when said device is within a case that is fitted within the docking port holder. For example, an electronic cable may be inserted in such connector housing, said electronic cable having a connecting end attached thereto, that will form the docking end. The connector housing is configured to allow such connecting end to extend above the platform, and to house said electronic cable connected to such connecting end.

The connector housing may be configured to incorporate an exit section 58 that is configured to provide support to the electronic cable extending from the docking end, such as a narrow exit section that holds the electronic cable in a particular position as it extends from the platform, and thereby provides support and stabilization to such electronic cable to protect it from damage that can occur upon twisting or bending of such electronic cable.

Said docking port holder may further incorporate a pin or notch 54, such as a depressible pin or notch configured to correspond to an indentation incorporated in the rear wall of the case. Such notch 54 is attached to or otherwise fitted within the locking element 34 when the case 10 is fitted within the docking port holder 40.

The platform may further incorporate detachable connector elements 62a, 62b, whereby the platform is connectable to a detachable facing.

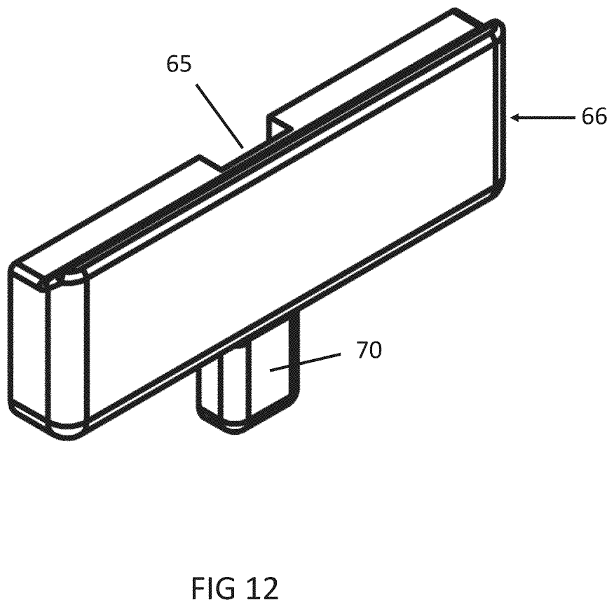

As shown in FIG. 12, a detachable facing 66 may be connectable to the platform of the docking port holder, whereby the elements of the platform become enclosed within a housing formed by the combination of the platform and the detachable facing. The detachable facing is detachably connected with the platform so that the elements of the platform are accessible by disconnecting the detachable facing from the platform. The elements positioned in the interior of the housing so formed are thereby accessible, such as, for example, for the purpose of removing an electronic cable from the connector housing, or for other purposes.

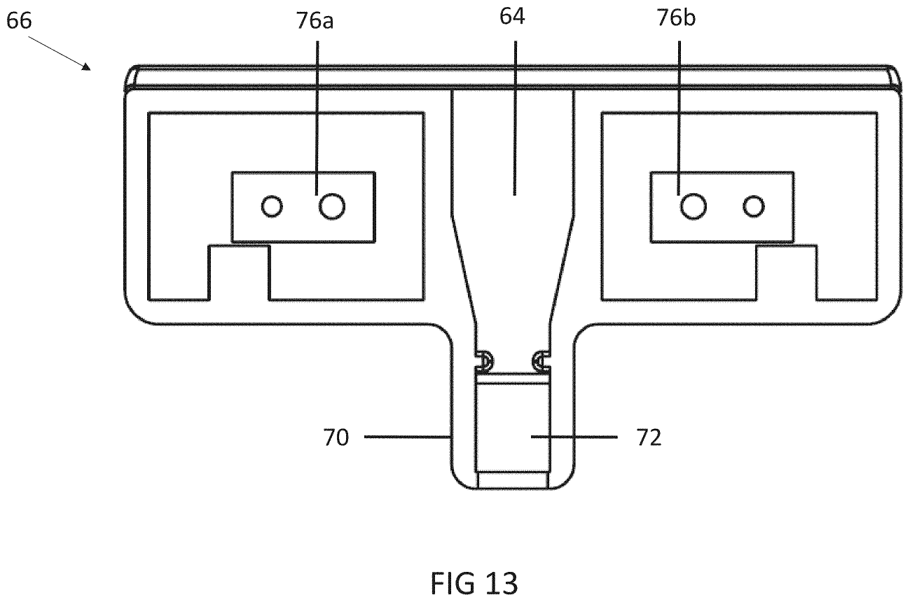

As shown in FIG. 13, the side of the detachable facing that faces the connector housing when the detachable facing is connected to the platform may incorporate facing detachable connector elements 76a, 76b. Such facing detachable connector elements are configured to correspond to the detachable connector elements of the platform, whereby the detachable facing is connectable and detachable from the platform. Such connection may be formed as a known detachable connection means.

The detachable facing is configured to integrate with the platform, for example, said facing may incorporate a docking end indentation 60 configured to accommodate a docking end, as well as an extension section 70 configured to incorporate an electronic cable indentation 72 to assist with the support of said electronic cable, and to connect with the exit section of the connector housing wherefrom an electronic cable connected to the docking end may extend.

As shown in FIG. 11, an air vent channel 69 is formed within the platform 59 of the docking port holder. Said air vent channel is configured to assist the fan system docking port holder to facilitate directing air towards the case.

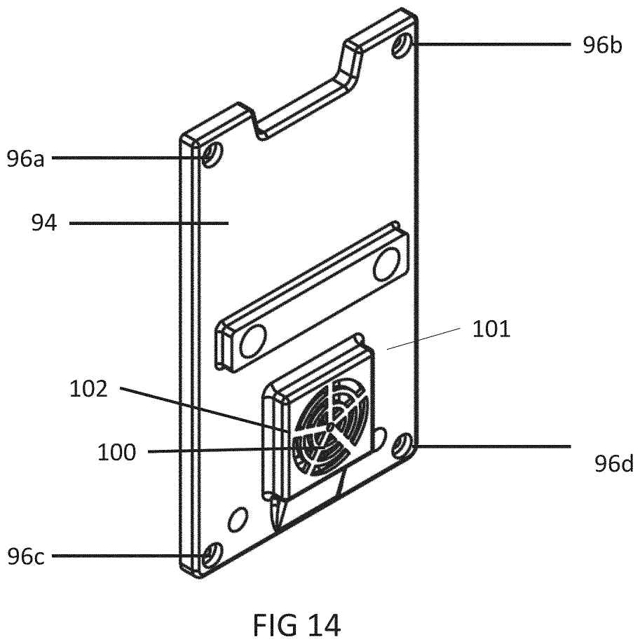

The air vent channel is connected to the fan system that, as shown in FIG. 14, is positioned in a detachable rear portion 94 of the docking port holder that incorporates a fan vent 100 in a fan protrusion 102 formed on the wall of the docking port holder that is distal from the guide rail path in the docking port holder, namely the outer docking port wall 101.

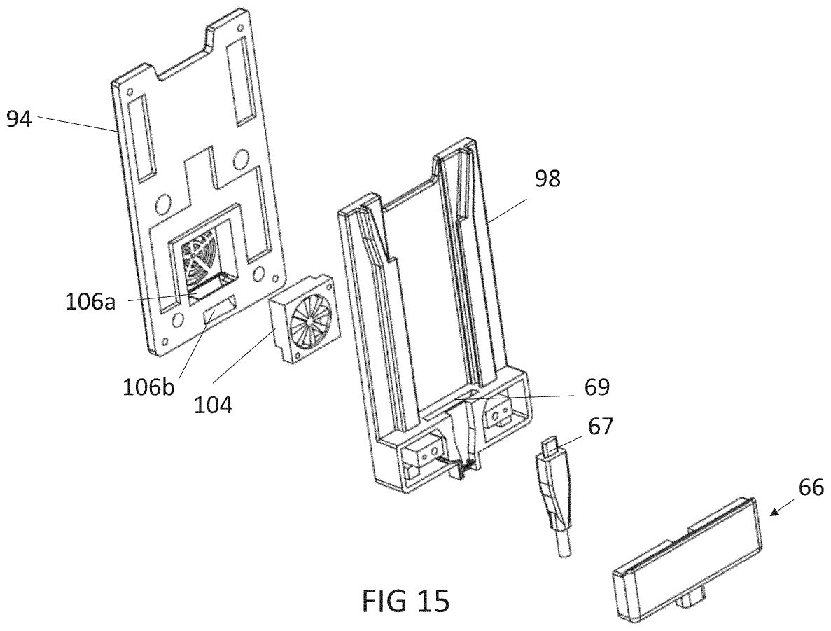

As shown in FIG. 15, the detachable rear portion 94 of the docking port holder can be detached from the detachable front portion 98 of the docking port holder. A fan 104 is positioned within the fan protrusion 102, and is thereby positioned proximate to the fan vent 100. Air is drawn into the fan via the fan vent from the exterior of the docking port holder. The fan pushes the air into the fan conduit opening 106a, through the fan conduit and out the fan conduit opening 106b, and from the fan conduit opening through the air vent channel 69. Once air passes through the air vent channel it is pushed into the case's air manifold entrance holes 36a, 36b, 36c, when the case 10 is docked into the docking port holder 40. The air is thereby pushed between the wall of the handheld computing device that is distal from the screen of the handheld computing device. The air then passes through at least one of the air flow indentations in the side of the rectangular wall of the case facing the handheld computing device, into at least one of the channels formed between the outerwall of the rectangular wall of the case and the guide rail panel, and out of at least one of the manifold exit holes 36d, 36e, 36f. The continuous flow of air over at least a portion of the handheld computing device prevents overheating of said handheld computing device when the handheld computing device is in use.

The fan may be operable to cool the temperature of the air flow that passes through the fan, and that is pushed into the case via the fan. This cooling function can further cause cooling of the handheld computing device when such cooled air contacts said handheld computing device and avoids overheating thereof. In embodiments of the present invention, the fan system may be operable by way of: a switch mechanism whereby a user can turn the fan on and off; by way of a connection to a sensor within the case that senses the temperature of the handheld computing device within the case and activates the fan to cool the handheld computing device as required in accordance with settings of a microprocessor attached to the sensor and the fan; or the fan system may operate whenever the case is fitted within the docking port holder.

As shown in FIG. 14, the docking port holder detachable rear portion 94 is removably attachable to the docking port holder detachable front portion 98 by use of screws or other fastening devices that can be inserted through the securing holes 96a, 96b, 96c, 96d formed proximate to or on the corners of the docking port holder rear attachment 96.

Embodiments of the present invention may incorporate a power cord in the port housing or the docking port holder, whereby electricity is provided to power the elements of the invention, including the handheld computing device, the one or more peripheral devices connected to the port housing, etc. Alternatively, embodiments of the present invention may incorporate a solar or battery power source. The battery or other power source in the handheld computing device may be recharged from the power source of the docking port holder or port housing when the handheld computing device is connected to the docking end.

It will be appreciated by those skilled in the art that other variations of the embodiments described herein may also be practiced without departing from the scope of the invention. Other modifications are therefore possible. For example, embodiments of the present invention may be configured for use in various industries, and the components of the present invention may be assembled in a variety of configurations.

We claim:

1. A computer system for mobile and stationary environments controlled by a handheld computing device, comprising:
a case for the handheld computing device, incorporating a guide rail panel thereon;
a docking port holder incorporating a guide rail path configured to connect with the guide rail panel; and
a port housing connected to the docking port holder and incorporating one or more ports.

2. The computer system of claim 1, wherein:
the guide rail panel is a protrusion disposed in the case, having guide rail panel walls extending between the case and the guide rail panel;
the guide rail path is an indentation in the docking port holder, having guide rail path walls extending between the docking port holder and the guide rail path; and
the guide rail path walls and the guide rail panel walls are configured to correspond to each other such that when fitted together a dovetail connection is formed.

3. The computer system of claim 2, wherein the docking port holder incorporates a connecting end that is a docking end, being connectable with a port disposed in the handheld device.

4. The computer system of claim 3, wherein the guide rail path is configured to incorporate a wider portion at an end distal from the docking end of the docking port holder, and said guide rail path tapers from such wider portion along the guide rail path walls.

5. The computer system of claim 4, wherein the guide rail path is operable to guide the case within the docking port holder by the connection of the guide rail path walls and the guide rail panel walls, to align the docking end and the corresponding port of the handheld computing device.

6. The computer system of claim 1, wherein the docking port holder incorporates a fan system, whereby air flow is generated and directed towards the case when said case is fitted in the docking port holder.

7. The computer system of claim 6, wherein the case incorporates:
manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case;
one or more airflow indentations extending from the wall of the case proximate or in contact with the handheld computing device is within said case to one or more channels formed between an outerwall of the case and the guide rail panel; and
one or more manifold exit holes extending from an end of the channel whereby air flow is dispelled from the one or more channels,
whereby air flow is continuously directed to the handheld computing device to prevent overheating of such handheld computing device.

8. The computer system of claim 1, wherein the one or more ports of the port housing are connectable to one or more periphery devices, and when said one or more periphery devices are so connected such one or more periphery devices are controllable by the handheld computing device.

9. The computer system of claim 1, wherein the docking port holder and the port housing are attachable to one or more surfaces.

10. A computer system for mobile and stationary environments controlled by a handheld computing device, comprising:
a case for the handheld computing device, incorporating a guide rail panel thereon; and
a docking port holder incorporating a guide rail path configured to connect with the guide rail panel and an air cooling system.

11. The computer system of claim 10, wherein the docking port holder incorporates a fan system, whereby air flow is generated and directed towards the case when said case is fitted in the docking port holder.

12. The computer system of claim 11, wherein the case incorporates:
manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case;
one or more airflow indentations extending from the wall of the case proximate or in contact with the handheld computing device is within said case to one or more channels formed between an outerwall of the case and the guide rail panel; and
one or more manifold exit holes extending from an end of the channel whereby air flow is dispelled from the one or more channels,
whereby air flow is continuously directed to the handheld computing device to prevent overheating of such handheld computing device.

13. A computer system for mobile and stationary environments controlled by a handheld computing device, comprising:
a case for the handheld computing device, incorporating a guide rail panel thereon; and
a docking port holder incorporating a guide rail path configured to connect with the guide rail panel and further incorporating one or more ports.

14. The computer system of claim 13, wherein:
the guide rail panel is a protrusion disposed in the case, having guide rail panel walls extending between the case and the guide rail panel;
the guide rail path is an indentation in the docking port holder, having guide rail path walls extending between the docking port holder and the guide rail path; and
the guide rail path walls and the guide rail panel walls are configured to correspond to each other such that when fitted together a dovetail connection is formed.

15. The computer system of claim 14, wherein the docking port holder incorporates a connecting end that is a docking end, being connectable with a port disposed in the handheld device.

16. The computer system of claim 15, wherein the guide rail path is configured to incorporate a wider portion at an end distal from the docking end of the docking port holder, and said guide rail path tapers from such wider portion along the guide rail path walls.

17. The computer system of claim 16, wherein the guide rail path is operable to guide the case within the docking port holder by the connection of the guide rail path walls and the guide rail panel walls, to align the docking end and the corresponding port of the handheld computing device.

18. The computer system of claim 13, wherein the docking port holder incorporates a fan system, whereby air flow is generated and directed towards the case when said case is fitted in the docking port holder.

19. The computer system of claim 18, wherein the case incorporates:
manifold entrance holes extending from a section of the base proximate to a port in the case that is connectable to a docking end in the docking port holder to a wall of the case proximate or in contact with the handheld computing device when the handheld computing device is within said case, whereby air flow is directed from the fan system into the case;
one or more airflow indentations extending from the wall of the case proximate or in contact with the handheld computing device is within said case to one or more channels formed between an outerwall of the case and the guide rail panel; and
one or more manifold exit holes extending from an end of the channel whereby air flow is dispelled from the one or more channels,
whereby air flow is continuously directed to the handheld computing device to prevent overheating of such handheld computing device.

20. The computer system of claim 13, wherein the one or more ports of the docking port holder are connectable to one or more periphery devices, and when said one or more periphery devices are so connected such one or more periphery devices are controllable by the handheld computing device and wherein the docking port holder is attachable to one or more surfaces.
